(19) United States
(12) Patent Application Publication
(10) Pub. No.: US 2007/0161745 A1
(43) Pub. Date: Jul. 12, 2007

(54) Associative thickener preparation

(76) Inventors: Helmut Coutelle, Freising (DE); Klaus Dziwok, Freilassing (DE)

Correspondence Address: MEYERTONS, HOOD, KIVLIN, KOWERT & GOETZEL, P.C., P.O. BOX 398, AUSTIN, TX, 78767-0398, US

(21) Appl. No.: 10/548,696

(22) PCT Filed: Mar. 7, 2004
(86) PCT No.: PCT/EP04/02326

§ 371 Date: Nov. 13, 2006

(30) Foreign Application Priority Data
Mar. 8, 2003 (DE) 103 10 175.6

(51) Int. Cl. C08G 67/02

(52) U.S. Cl. 524/612

(57) ABSTRACT

An associative thickener preparation having a viscosity in aqueous solution of less than 25 000 mPa·s is described, comprising (a) a combination of at least one associative thickener (A) having a structural viscosity and at least one Newtonian associative thickener (B); and/or (b) a combination of at least one associative thickener (A) having a structural viscosity, at least one Newtonian associative thickener (B) and at least one thinner (C); and/or (c) a combination of at least one associative thickener (A) having a structural viscosity, at least one Newtonian associative thickener (B) and at least one wetting agent; and/or (d) a combination of at least one associative thickener (A) having a structural viscosity, at least one Newtonian associative thickener (B) and at least one solvent; and/or (e) a combination of at least one associative thickener (A) having a structural viscosity, at least one Newtonian associative thickener (B), at least one solvent and at least one wetting agent; and/or (f) a combination of at least one thickener (A) having a structural viscosity and at least one thinner (C); and/or (g) a combination of at least one Newtonian thickener (B) and at least one thinner (C).

Associative thickeners are thickeners which have been known for many years and are intended for aqueous systems. They are used, inter alia, in dispersion-bound water-based paints and finishes but also other aqueous systems, for example cleaning agents, cosmetics, pickles, aqueous pigment pastes, automotive finishes, industrial coatings, printing inks, lubricating greases, plaster paints and wall paints, textile coatings, pharmaceutical preparations, crop protection formulations, filler dispersions, adhesives, detergents, wax dispersions, polishes, auxiliaries for tertiary mineral oil production etc., are adjusted rheologically therewith.

The typical mode of action of these thickeners is due to their chemical composition. In general, associative thickeners consist of a water-soluble hydrophilic main part, i.e. a water-soluble polymer chain which for the most part comprises polyethylene glycol or comprises cellulose derivatives, acrylate chains, polyether chains or polyester chains, hydrophobic groups being attached to these polymer chains. The two parts are bound to one another on a very wide range of types of covalent bonds. The link here can be effected, for example, by urethane bonds, ester bonds, ether bonds, urea bonds, carbonate bonds or amide bonds.

The customary preparation of the associative thickeners is effected by reacting, for example, bifunctional alcohols (usually polyethylene glycol) with bifunctional reactants (usually diisocyanates) in a polyaddition reaction and terminating the addition reaction by adding monofunctional reactants (e.g. monofunctional alcohols, such as nonylphenol ethoxylate). The hydrophobic groups required for the formation of the associative interaction are then present as terminal groups bonded to the water-soluble polymer chain.

The hydrophilic moiety remains dissolved in the aqueous phase in the application system. The hydrophobic groups, however, accumulate at hydrophobic surfaces, for example on the dispersed or emulsified organic binders in an aqueous coating, for example an emulsion paint, on the hydrophobic surfaces of fillers, pigments, etc. Since a thickener polymer usually has two terminal (or a plurality of additional) hydrophobic moieties, it may link simultaneously to a plurality of dispersion particles. These are linked to one another with the aid of the hydrophilic base chain. It forms as a result of a thickening effect which is based on the association of the hydrophobic or of the less water-soluble moieties and the build-up of a three-dimensional network by means of van der Waals' interaction in the aqueous system. Hence the name associative thickener.

It is in the nature of this mechanism that the hydrophobic moieties associate, however, not only with the hydrophobic components, for example, in a paint. In the absence of a dispersion or other hydrophobic components the hydrophobic groups also associate with one another and form, for example, micelles. This too leads to thickening. This thickening also takes place when only the thickener polymer alone is dissolved in water. Since the customary form of delivery of the polymer is an aqueous solution, it is self-evident that excessive thickening is not desired here. This in fact complicates the processing and the handling or limits the maximum concentration of the soluble thickener polymer in water to a few percent.

Through the choice of the hydrophobic terminal groups and/or adjustment of the molecular weight, the rheological effects of the thickener can be adjusted so that Newtonian associative thickeners (B) or associative thickeners (A) having a relatively pronounced structural viscosity form. In the case of the latter, the thickening in water alone is particularly pronounced owing to the intermolecular interaction, and the necessity of reducing the viscosity is particularly great in order to be able here too to offer acceptable polymer concentrations in a form which can be handled.

In order to suppress the high viscosity of the associative thickener (A) having a structural viscosity in water alone and thus to make the thickener easier to handle or to be able to offer it in a higher concentration, a large number of possibilities have already been worked out and have also been implemented and applied for years.

The customary method for reducing the viscosity is the addition of solvents. In particular, glycols, such as propylene glycol, butylglycol, butyldiglycol and butyltriglycol, are used for this purpose. These products are, however, typical solvents which can be released into the environment. They are therefore no longer desired in more recent paint formulations, for example for ecological reasons. The diluting effect is substantially based on the fact that these solvents themselves have a typical surfactant-like structure with a readily water-soluble end result (alcohol/glycol) and water-insoluble moiety (butyl group, etc.). By addition of the hydrophobic alkyl radical to the hydrophobic group of the associative thickener molecule, the polarity is reversed and the intensive interaction of the thickener molecules with one another is suppressed or reduced. It is also partially evident from the phenomenon that thickener solutions made fluid in this manner initially become thicker on addition of water, since the readily water-soluble solvents are diluted and their effect thus reduced.

In the development of VOC-free (VOC=volatile organic content) or emission-free paints and finishes, the desire for associative thickeners which are free of these solvents was communicated to the manufacturers. One method for achieving this is described in EP-A-0 614 950. Here, cyclodextrin is used in order to suppress the solution viscosity of associative thickeners having a high structural viscosity in the form for delivery, without using solvents. The hydrophobic moieties of the thickener are adsorbed in the hydrophobic moieties of the cyclodextrin and prevented from undergoing mutual interactions. A disadvantage is that the cyclodextrins remain in the system, for example in the paint, after liberation of the associative thickener. These adsorption sites now vacated once again in the cyclodextrin can therefore adsorb other components of the formulation, such as, for example, wetting agents and dispersants, and hence make them ineffective. In addition to other problems, this can also lead to stability problems in the system, such as, for example, a paint. Consequently, the added amount of these necessary additives has to be optimized and the formulation adapted to the thickener, which is not desired.

A further method has likewise been used for years. Here, the property of true nonionic surfactants or emulsifiers (in comparison with butyldiglycol and other higher molecular weight materials) is utilized for reducing the viscosity of associative thickeners. These are not released by “evaporation” into the environment since their boiling point is too high and thus remain for the most part in the coating, for example after the paint has dried on. However, they then have the disadvantage of adversely affecting the water resistance, for example, of these paints, since they make the paint film more readily swellable and detachable than water-soluble and hence also water-attracting components. Furthermore, their use can lead to foam problems in paint production.

For this reason, the further addition of an “antifoam” (“Surfynol”), in addition to the (reduced) solvent content and a surfactant is also described in EP-B-0 682 094.

Further prior art in these areas are, for example, WO 00/00539, DE-A-196 44 933, DE-A-43 10 702, DE-A-195 23 837, DE-A-196 00 467, U.S. Pat. No. 4,079,028 and DE-A-14 44 243.

In US-A-2002/0052441 sodium formate is described as an additive. However, salts give rise to considerable water resistance problems in industrial coatings and also decorative finishes.

The use of polypropylene glycols or polybutylene glycols in thickeners has been described in numerous patent applications or the possibility also mentioned, for example in EP-A-0 031 777. Here, the purpose of the polypropylene glycol content is merely to achieve a reduction in melting point. According to WO-A-01/85821 the thickener is said to be soluble in solvents, not in water, as a result of the addition of polybutylene glycol. According to EP-B-0 642 557, there is no defined sense or advantage at all of a possible proportion of a polypropylene glycol in the thickener. In none of said cases was a viscosity-reducing effect on the aqueous solution viscosity of the thickener polymers by the replacement or partial replacement of polyethylene glycol by propylene glycol or butylene glycol described.

DE-A-36 30 319 describes polyurethane thickeners based on polypropylene glycol/polyethylene glycol copolymers. Here, the desired thickeners themselves are said to be liquids, not solids, which are therefore said to be pourable directly, without prior dissolution in water, and are therefore not dissolved in the form delivered in water but are present in liquid form virtually as 100% strength active substance. Here too, it is mentioned that the thickening profile in the application system can be varied by a combination of a plurality of thickeners. However, the influence of the mixing of thickeners or the influence of propylene glycol/polyethylene glycol copolymer moieties in the thickener on the reduction of the solution viscosity of the thickener polymers in water was not mentioned or recognized. However, it is generally known that 100% strength associative thickeners, whether liquid or in powder form, are difficult to incorporate into aqueous systems since they have a strong tendency to agglomerate. For this reason alone, thickeners which are predissolved in water and can be added without problems and in a flexible manner to the aqueous system are predominantly used if the viscosity is sufficiently low for the system to be pourable.

However, all these proposals have the disadvantage that the additions suppress or reduce the trend in viscosity in water in the desired manner, but these additions are undesired for ecological reasons (solvent/cosolvent) or generally have adverse side effects in the resulting coating film.

The object of the present invention was therefore to provide an associative thickener which can be dissolved in as high a concentration as possible in water without having too high a viscosity due to intermolecular association. Furthermore, it was intended to reduce the viscosity without having to use solvents or thinners which, in accordance with the VOC directive, may enter the atmosphere (i.e. substances having a boiling point <250° C.) or release emissions, for example ammonia or formaldehyde, into the environment. According to RAL-ZU 102 (Principles of environmental code allocation of May 2000, page 3) VOCs are to be understood as meaning all organic substances which are eluted up to the retention time of the substance tetradecane (boiling point: 252.6° C.) on a nonpolar separation column by total evaporation and subsequent gas chromatographic analysis.

Finally, it was intended to find a possibility for suppressing the viscosity where only rheologically active components are used.

Surprisingly, it was found that the viscosity of an associative thickener preparation in aqueous solution can be reduced to less than 25 000 mPa·s if the associative thickener preparation comprises:
(a) a combination of at least one associative thickener (A) having a structural viscosity and at least one Newtonian associative thickener (B); and/or
(b) a combination of at least one associative thickener (A) having a structural viscosity, at least one Newtonian associative thickener (B) and at least one thinner (C); and/or
(c) a combination of at least one associative thickener (A) having a structural viscosity, at least one Newtonian associative thickener (B) and at least one wetting agent; and/or
(d) a combination of at least one associative thickener (A) having a structural viscosity, at least one Newtonian associative thickener (B) and at least one solvent; and/or
(e) a combination of at least one associative thickener (A) having a structural viscosity, at least one Newtonian associative thickener (B), at least one solvent and at least one wetting agent; and/or
(f) a combination of at least one thickener (A) having a structural viscosity and at least one thinner (C); and/or
(g) a combination of at least one Newtonian thickener (B) and at least one thinner (C).

Since the transition from Newtonian thickener (B) to associative thickener (A) having a structural viscosity is fluid, the following definition is applicable according to the invention:

an associative thickener is referred to as being Newtonian (B) if its solution viscosity in 20% strength aqueous dispersion is less than 20 000 mPa·s (Brookfield viscometer, 20 rpm).

In order to be referred to as an associative thickener and in order to ensure a substantial distinction from low molecular weight surfactants, said thickener should, however, simultaneously effect thickening in an emulsion system. In order to determine this, 2.5 parts of the thickener are stirred homogeneously into a mixture of 100 parts by weight of Acronal 290D (BASF, aqueous styrene-acrylate dispersion), 30 parts by weight of demineralized water and 0.3 part by weight of antifoam ADDID 800 (Wacker, silicone antifoam for aqueous dispersions). The viscosity at 10 000 sec⁻¹ (Bohlin viscometer) after a ripening time of 4 hours is at least 50% above that of the zero sample. At the same time, the molecular weight should be above 2500 g/mol, in particular above 1000 g/mol.

An associative thickener is referred to here as having a structural viscosity (A) if its solution viscosity in 20% strength aqueous solution is more than 100 000 mPa·s and the viscosity in the Acronal test system at a shear rate of 1 sec⁻¹ is more than 10 000 mPa·s (for this measurement, 16% by weight of butyldiglycol, as a viscosity-reducing substance, is added to the associative thickener having a structural viscosity, in order for it to be processable: 20% by weight of thickener+16% by weight of butyldiglycol+64% by weight of water).

The combination, according to the invention, of associative thickener (A) having a structural viscosity and Newtonian thickener (B) and/or thinner must have a low-shear thickening at 1 sec⁻¹ of at least 10 000 mPa·s in the Acronal system as 20% strength solution in order to be considered as having a structural viscosity and being efficient in the application test system. For this purpose, 2.5 g of the thickener are homogeneously stirred into a mixture of 100 g of Acronal 290D (BASF), 30 g of demineralized water and 0.3 g of antifoam ADDID 800 (Wacker) and measured after a stirring time of 4 hours.

Preferred embodiments of the invention are described in the subclaims.

The invention furthermore relates to a process for the preparation of the associative thickener preparation defined above, which is characterized in that
a) at least one associative thickener (A) having a structural viscosity is dissolved in water together with at least one Newtonian associative thickener (B);
b) at least one associative thickener (A) having a structural viscosity is dissolved in water together with at least one Newtonian associative thickener (B) and at least one thinner (C);
c) at least one associative thickener (A) having a structural viscosity is dissolved in water and at least one thinner (C) is added;
d) at least one associative thickener (A) having a structural viscosity and a Newtonian associative thickener (B) for further reduction of the viscosity are dissolved in water together with a solvent and/or surfactant, the surfactant used being a dispersant and/or wetting agent and the solvent used being a glycol having a boiling point of >250° C.

The invention furthermore relates to the use of the associative thickener preparation defined above for adjusting the rheology of dispersion-bound water-based paints and finishes or other aqueous systems from the group consisting of cleaning agents, cosmetics, pickles, aqueous pigment pastes, automotive finishes, industrial coatings, printing inks, lubricating greases, plaster paints and wall paints, textile coatings, pharmaceutical preparations, crop protection formulations, filler dispersions, adhesives, detergents, wax dispersions, polishes and auxiliaries for tertiary mineral oil production.

It was surprisingly found that the addition of a Newtonian associative thickener (B) which is soluble in water alone to a thickener (A) having a structural viscosity and dissolved in water alone does not result in the expected additional large increase in viscosity in the aqueous form for delivery as would have been achievable on addition of the individual viscosities of separate solutions. Depending on the choice of the ratios and on the type of the two thickeners, the reduction of the viscosity of the thickener having a structural viscosity, dissolved in water alone, is even possible although the total polymer content of the aqueous dispersion is substantially increased. An addition of solvents is not necessary in order to avoid exceeding the maximum viscosity of 25 000 mPa·s.

Aqueous solutions of an associative thickener (A) having a structural viscosity were prepared without addition of solvents or thinners. The concentration was reduced stepwise downward from 20% by weight. A concentration at which the solution viscosity was lower than 25 000 mPa·s was determined. The lacking amount to 20% of undissolved 100% strength Newtonian associative thickener (B) was then added to this solution. In the cases mentioned in the examples, in no case was the solution viscosity increased thereby in the same ratio as Newtonian thickener was added. In most cases, the viscosity remained at or below the value of the viscosity of the thickener fraction having a structural viscosity alone and did so although the total polymer content of associative thickeners was increased up to 5-fold. Usually, the increase in viscosity on addition of thickener in the case of individual thickener in the superlinear additive range takes place roughly exponentially in the relevant viscosity range from 2000 to 25 000 mPa·s.

Despite the fact that the solution viscosity has not increased, the addition of the Newtonian thickener (B) to the application system results in substantially greater thickening. Particularly in the high-shearing range, extreme increases are observed.

The addition of a Newtonian thickener (B) to an associative thickener having a structural viscosity leads in the application system to an increased thickening effect. In the aqueous solution, on the other hand, the addition of the Newtonian thickener (B) results only in a subadditive increase in the solution viscosity or even reduced viscosity compared with that of the thickener fraction having a structural viscosity alone.

Depending on the chemical composition of the associative thickener (A) having a structural viscosity, a special Newtonian associative thickener (B) may in certain circumstances be necessary to achieve a particularly good reduction in the viscosity.

The viscosity of an aqueous solution of a thickener (A) having, for example, a structural viscosity in water can, however, thus be suppressed by special thinners (C), for example by the copolymers described in more detail below. The alternating hydrophilic/hydrophobic copolymer can be prepared by cocondensation or copolymerization of hydrophilic molecules or oligomers (D) with hydrophobic molecules (E).

The hydrophilic molecules or oligomers (D) may be selected from Z-[CH₂CH₂O]ₘ—CH₂CH₂-Z₂, where m=0 to 15, preferably m=2 to 6, and Z and Z₂, which are identical to or different from one another, are a group containing an active hydrogen, such as OH, NH₂ or secondary amines. Short-chain polyethylene glycols are preferably used.

The hydrophobic moieties (E) may be selected from X—R—X₂, where R is a saturated or unsaturated aliphatic or cycloaliphatic radical having 2 to 12 carbon atoms, preferably having 3 to 6 carbon atoms, or an aromatic radical having 6 to 12 carbon atoms, or a mixed aromatic/aliphatic radical having 6 to 17 carbon atoms and X and X₂, which are identical to or different from one another and are a function which can be reacted with Z and Z₂, for example a carboxyl, carboxylic anhydride, acyl chloride, ester, isocyanate or epoxide group or a halogen ion. Adipic acid, phthalic anhydride or dimethyl terephthalate are preferably used. The ratio of D/E is about 6:5 to 5:6, preferably about 3:2 to 2:3, in particular about 2:1 to 1:2.

These materials therefore also differ substantially from the customary materials used as plasticizers, according to VdL-RL 01 (Guideline on the declaration of ingredients in structure finishes, structure paints and related products, revised edition of April 2000), in which, for example, di-n-octyl phthalate, di-n-butyl phthalate, etc. are mentioned. In contrast to the abovementioned thinners, these materials contain no hydrophilic component at all.

In Farbe & Lack [Paint & Finish], July 2002, Gerald Altnau page 37 et seq., dibasic esters of adipic acid are proposed as film-forming auxiliaries or VOC-free solvent, owing to their high boiling point and low vapor pressure. Copolymers of dibasic acids with polyethylene glycols are not mentioned. The use as thinner (C) in associative thickener preparations accordingly also saves the addition of film auxiliaries or reduces the use thereof.

One or two terminating end groups having only one reactive function Z, Z₂, X or X₂ may optionally be contained.

The use of short-chain ethylene glycols in a small molar excess additionally results in the desired property that the oligomer or polymer itself is poorly soluble in water and in some cases exhibits phase separation with water but nevertheless has viscosity-reducing properties in the test system and is present homogeneously distributed therein without phase separation. In the application system, this results in an improvement in the water resistance after drying of the finish. With the use of the acid in excess and subsequent neutralization in aqueous NaOH, after evaporation of the water at acid numbers from about 80 mg KOH/g.

Copolymers of ethylene glycol and propylene glycol and/or butylene glycol can also be used as alternating hydrophilic/hydrophobic copolymers. Here, the random copolymers are preferred to the block copolymers. The copolymer may be added in addition to the thickener as a pure thinner or can be covalently bonded in the thickener. Polypropylene glycol moieties or polypropylene/polyethylene glycol copolymers, incorporated in the thickener polymer, reduce the solution viscosity of the thickener in water. Straightforward admixing of polypropylene glycol/polyethylene glycol copolymers likewise reduces the aqueous solution viscosity of the thickener. The molar fraction of propylene glycol and/or butylene glycol in the polyethylene glycol is ideally from 10 to 60 mol %. Pure polypropylene glycols are too poorly water-soluble and have a poorer thinning effect, as do pure polybutylene glycols. Relatively short-chain propylene glycols or butylene glycols can however be used, are water-soluble and have a thinning effect. These are preferably oligomeric propylene glycols or butylene glycols having up to 10 monomer units. The propylene glycols preferably have a molecular weight of up to about 700 g/mol, and the butylene glycols a molecular weight of up to about 500 g/mol. Block copolymers, such as, for example, PEG-PPG-PEG (polyethylene glycol-polypropylene glycol-polyethylene glycol) are as a rule less effective. Polyethylene glycol polymers are readily soluble but their action is insufficient.

Furthermore, hexanediol can also be used. This has a boiling point of above 253° C. and is thus no VOC; moreover, it has the additional advantage that it is solid at room temperature and hence does not increase the tack and dirt uptake of the coating film.

The following examples are intended to explain the present invention in more detail without limiting the possibilities of the method. The following examples were prepared for illustrating the efficiency. For comparison reasons, a solids content of 20% by weight of the water-soluble polymer in water was predominantly employed. In addition to the amount of 20% by weight of an associative thickener or a corresponding mixture of associative thickeners (A+B), thinners or—for comparison therewith—standard solvents were additionally used.

Hydrophobically modified, ethoxylated aminoplasts, i.e. the pure 100% strength solid polymers (without water and butyldiglycol) of the following commercial products of Süd-Chemie AG, were used as thickeners (A) having a structural viscosity. The solid polymers can be obtained by evaporating the solvents from the commercial products; however, it was also possible to use the polymers directly after the preparation, even before dissolution:
H375 (solid polymer of commercial product Optiflo H370)*
H405 (solid polymer of commercial product Optiflo H400)*
H605 (solid polymer of commercial product Optiflo H600)*
   * For solution viscosity in water, cf. table I or II

Hydrophobically modified ethoxylated aminoplasts, i.e. the pure solid polymers (without water) of the following commercial products of Süd-Chemie AG were likewise used as Newtonian thickeners (B):
L105 (solid polymer of commercial product Optiflo L100)*
L155 (solid polymer of commercial product Optiflo L150)**
   * For solution viscosity in water, cf. table II
   ** Solution viscosity, 20% by weight in water, from 10 000 to 12 000 mPa·s

The degree of hydrophobization is higher in the case of the H type than in the case of the L types.

In order to show clearly that this invention is not limited only to the solids fractions of existing commercial products but is generally applicable, the further simple model thickeners mentioned in the examples were prepared by the preparation processes described in WO 96/40815, WO 96/40625 and WO 96/40626 and were tested.

The raw materials were used in the molar ratio. The individual amount used was calculated on the basis of the total amount used in the stated patent applications. The catalysts were used in the same ratios as stated in the patent applications.

### EXAMPLES 1 TO 10 (COMPARISON)

In example 1, the viscosity of the test binder, Acronal 290 D from BASF (styrene-acrylate dispersion) is stated. In examples 2 to 10, both the viscosities of the various aqueous solutions of a thickener (H375) having a structural viscosity are stated, as well as, in some cases, the thickening effect of these associative thickener solutions in Acronal 290 D. The results are stated in table I.

TABLE I
Comparative values of the thickener H375 having a
structural viscosity

| | | Solution | Acronal viscosity | | |
|---|---|---|---|---|---|
| | | viscosity in | (mPa · s/Bohlin) at a | | |
| | | water (mPa · s) | shear rate D of | | |
| | Mixture (% | (Brookfield, | | 100 | 10000 |
| Example | polymer in water) | 20 rpm) | 1 sec⁻¹ | sec⁻¹ | sec⁻¹ |
| 1 | without thickener | | 120 | 50 | 15 |
| 2 | 20% H375 | >100000 | | | |
| 3 | 20% H375 + | 3000 | 50000 | 4800 | 76 |
| | 16% BDG | | | | |
| 4 | 20% H375 + | 6400 | 39000 | 6000 | 95 |
| | 20% hexanediol | | | | |
| 5 | 13.3% H375 | >100000 | | | |
| 6 | 10% H375 | 61700 | | | |
| 7 | 6.7% H375 | 27700 | | | |
| 8 | 5% H375 | 13400 | 15700 | 1300 | 33 |
| 9 | 4% H375 | 8200 | 10000 | 900 | 29 |
| 10 | 2% H375 | 670 | | | |

### EXAMPLES 11 TO 15 (ACCORDING TO THE INVENTION) AND EXAMPLES 16 AND 17 (COMPARISON)

The results are stated in table II.

As shown by examples 11 to 15, the viscosity of the thickener mixtures in water is below the expected additive viscosity of the individual components; this is not the case in the test binder. The viscosity there substantially corresponds to the additive viscosity, or an even greater thickening is present.

TABLE II
Mixtures of thickeners having a structural viscosity
and Newtonian thickeners
having a structural viscosity H375
Newtonian L105

| | | Solution | Acronal viscosity | | |
|---|---|---|---|---|---|
| | | viscosity in | (mPa · s) at a | | |
| | | water (mPa · s) | shear rate D of | | |
| | Mixture (% | (Brookfield, | 1 | 100 | 10000 |
| Example | polymer in water) | 20 rpm) | sec⁻¹ | sec⁻¹ | sec⁻¹ |
| 11 | 4% H375 + | 9500 | 11600 | 1480 | 88 |
| | 16% L105 | | | | |
| 12 | 5% H375 + | 10000 | 18300 | 1960 | 99 |
| | 15% L105 | | | | |
| 13 | 6.7% H375 + | 16600 | 22800 | 2300 | 95 |
| | 13.3% L105 | | | | |
| 14 | 10% H375 + | 52400 | | | |
| | 10% L105 | | | | |
| 15 | 13.3% H375 + | 130000 | | | |
| | 6.7% L105 | | | | |
| 16 | 16% L105 | 1900 | | | |
| 17 | 20% L105 | 3200 | 3200 | 500 | 88 |

### EXAMPLES 18, 20, 22, 24, 25, 27, 29, 31, 33, 35, 40, 44 TO 46, 49, 50 (ACCORDING TO THE INVENTION) AND 19, 21, 23, 26, 28, 30, 32, 34, 36, 37 TO 39, 41 TO 43, 47, 48 (COMPARISON)

The values of table III show the reduction in viscosity of aqueous solutions of thickeners having a structural viscosity (in this case H375, H405, H605 or V1) as a result of the addition of Newtonian thickeners (in this case L105, L155, V4, V5, V6, V8, V9, V10, V11, V12) in comparison with the thinning effect of the standard solvent butyldiglycol (BDG). As is evident, the thickening effect of the preparations according to the invention in the test binder is nevertheless similar to that of the pure addition of the individual contributions of the thickeners A+B (example 24 or 27), although the solution viscosity in water is lower than would be expected in the case of a combination of A+B.

As shown by examples 47 to 50, it is entirely possible, for a thickener (V1) having a structural viscosity to prepare a Newtonian thickener which has a particularly good diluting effect by modifying the composition (V4 compared with L155).

TABLE III
Mixtures of thickeners having a structural viscosity
and Newtonian thickness
having a structural viscosity H375, H405, H605, V1
Newtonian L105, L155, V2 to V13

| | | | Solution | Acronal viscosity | | |
|---|---|---|---|---|---|---|
| | | | viscosity in | (mPa · s) at a | | |
| | Mixture (% | | water (mPa · s) | shear rate D of | | |
| | polymer | | (Brookfield, | | | 10000 |
| Ex. | in water) | | 20 rpm) | 1 sec⁻¹ | 100 sec⁻¹ | sec⁻¹ |
| 18 | 5% H375 + | Inv. | 2800 | 13500 | 1530 | 73 |
| | 15% V11 | | | | | |
| 19 | 20% V11 | Com. | 500 | 530 | 200 | 66 |
| 20 | 5% H375 + | Inv. | 4600 | 17600 | 2000 | 108 |
| | 15% V12 | | | | | |
| 21 | 20% V12 | Com. | 1100 | 3000 | 700 | 114 |
| 22 | 5% H375 + | Inv. | 7600 | 22200 | 2270 | 97 |
| | 15% V6 | | | | | |
| 23 | 20% V6 | Com. | 2100 | 2400 | 540 | 75 |
| 24 | 5% H375 + | Inv. | 6600 | 26900 | 2660 | 105 |
| | 15% V4 | | | | | |
| 25 | 4% H375 + | Inv. | 4750 | 16000 | 2100 | 96 |
| | 16% V4 | | | | | |
| 26 | 20% V4 | Com. | 1300 | 2700 | 750 | 85 |
| 27 | 5% H375 + | Inv. | 4400 | 22100 | 2100 | 63 |
| | 15% V5 | | | | | |
| 28 | 20% V5 | Com. | 900 | 1000 | 350 | 55 |
| 29 | 5% H375 + | Inv. | 3900 | 18350 | 1730 | 47 |
| | 15% V8 | | | | | |
| 30 | 20% V8 | Com. | 1200 | 550 | 150 | 29 |
| 31 | 5% H375 + | Inv. | 13700 | 20300 | 1730 | 40 |
| | 15% V10 | | | | | |
| 32 | 20% V10 | Com. | 2500 | 120 | 51 | 19 |
| 33 | 5% H375 + | Inv. | 8400 | 20600 | 1850 | 60 |
| | 15% V13 | | | | | |
| 34 | 20% V13 | Com. | 2300 | 3100 | 470 | 51 |
| 35 | 5% H375 + | Inv. | 12000 | 20900 | 2000 | 58 |
| | 15% V9 | | | | | |
| 36 | 20% V9 | Com. | 4100 | 3600 | 630 | 46 |
| 37 | 20% H605 | Com. | >100000 | | | |
| 38 | 20% H605 + | Com. | 5000 | 60000 | 4400 | 68 |
| | 16% BDG | | | | | |
| 39 | 4% H605 | Com. | 91500 | 7300 | 640 | 28 |
| 40 | 4% H605 + | Inv. | 9850 | 35000 | 3000 | 120 |
| | 16% V4 | | | | | |
| 41 | 20% H405 | Com. | >100000 | | | |
| 42 | 20% H405 + | Com. | 3000 | 46000 | 3900 | 92 |
| | 16% BDG | | | | | |
| 43 | 4% H405 | Com. | 44600 | 5200 | 550 | 27 |
| 44 | 4% H405 + | Inv. | 15000 | 8100 | 250 | 93 |
| | 16% L105 | | | | | |
| 45 | 4% H405 + | Inv. | 5700 | 8500 | 1300 | 89 |
| | 16% V4 | | | | | |
| 46 | 5% H405 + | Inv. | 21000 | 10200 | 1420 | 97 |
| | 15% L105 | | | | | |
| 47 | 4% V1 | Com. | >100000 | 8500 | 750 | 24 |
| 48 | 20% V1 + | Com. | 10500 | 43000 | 2900 | 37 |
| | 16% BDG | | | | | |
| 49 | 4% V1 + | Inv. | 71000 | | | |
| | 16% L155 | | | | | |
| 50 | 4% V1 + | Inv. | 31000 | 12000 | 1900 | 89 |
| | 16% V4 | | | | | |

### EXAMPLES 51 TO 59

Table IV shows the effect of various novel thinners (C) on the solution viscosity of the thickeners H375 and H605 having a structural viscosity.

The thinners (C) were prepared as follows:

Method 1 (Starting from the Ester):

101 g of tetraethylene glycol (0.5 mol) were dried for 2 hours at 100° C. and 20 hPa. Thereafter, 90 g of dimethyl adipate (0.5 mol) and then 1 g of 30% strength methanolic solution of NaOMe are added. The methanol formed is removed in vacuum at 100° C. with stirring until the bubble formation has ceased. The vacuum is then broken, whereupon 0.3 g of glacial acetic acid (equimolar with NaOMe used) is stirred in.

Method 2 (Starting from the Acid):

Instead of X,X₂=ester on the hydrophobic moiety (E), X,X₂=acid is used. The reaction is carried out under toluenesulfonic acid catalysis at about 120-220° C. in vacuum and is stopped as soon as the major part of the theoretically calculated water has been removed in vacuum and deposited in the cold trap. Optionally, xylene is used as an entrainer for residual traces of water, and the xylene/water mixture is collected in a water separator.

The products are slightly viscous to viscous/solid.

As shown in table IV, the thinning effect of the thinners C1 to C9 (examples 51 to 59) was tested. Commercially available copolymers (C10 to C15) were also tested as thinners (examples 60 to 66). The esters (C1 to C9) show a pronounced thinning effect. Copolymer C10 is also effective as a thinner. The thickening effect in the test binder is very pronounced and is approximately equivalent to the preparation prepared using the standard thinner BDG, in some cases even higher (examples 53, 57 and 61) than the comparison with the standard thinner BDG (example 3). The homopolymers or block copolymers C11 to C15 are far less effective as thinner than the random hydrophilic-hydrophobic copolymer C10.

TABLE IVa
Addition of a thinner C1 to C9
hydrophobic/hydrophilic copolymers admixed with the
thickener having a structural viscosity

| | | Solution viscosity | Acronal viscosity (mPa · s) | | |
|---|---|---|---|---|---|
| | Mixture | in water (mPa · s) | at a shear rate D of | | |
| | (% polymer | (Brookfield, | | | 10000 |
| Ex. | in water) | 20 rpm) | 1 sec⁻¹ | 100 sec⁻¹ | sec⁻¹ |
| 51 | 15% H375 + | 12000 | 26000 | 4400 | 69 |
| | 16% C1 | | | | |
| 52 | 15% H375 + | 4000 | 22000 | 4100 | 64 |
| | 16% C2 | | | | |
| 53 | 20% H375 + | 23200 | 70000 | 6000 | 102 |
| | 20% C3 | | | | |
| 54 | 20% H375 + | 9900 | 36000 | 5800 | 88 |
| | 20% C4 | | | | |
| 55 | 20% H375 + | 12700 | 43000 | 5900 | 86 |
| | 20% C5 | | | | |
| 56 | 20% H375 + | 13700 | 47000 | 5600 | 83 |
| | 20% C6 | | | | |
| 57 | 20% H375 + | 8100 | 60000 | 6100 | 80 |
| | 20% C7 | | | | |
| 58 | 20% H375 + | 11000 | 30000 | 6300 | 82 |
| | 20% C8 | | | | |
| 59 | 20% H375 + | 18300 | 24000 | 6900 | 92 |
| | 20% C9 | | | | |

TABLE IVb
Addition of a thinner C10
random PPG/PEG (1:1) polyglycol mixed with the
thickener having a structural viscosity

| | | Solution viscosity | Acronal viscosity (mPa · s) | | |
|---|---|---|---|---|---|
| | Mixture | in water (mPa · s) | at a shear rate D of | | |
| | (% polymer | (Brookfield, | | | 10000 |
| Ex. | in water) | 20 rpm) | 1 sec⁻¹ | 100 sec⁻¹ | sec⁻¹ |
| 60 | 20% H375 + | 8200 | 32000 | 5900 | 82 |
| | 20% C10 | | | | |
| 61 | 20% H605 + | 21500 | 96000 | 5600 | 73 |
| | 20% C10 | | | | |
| 62 | 20% H375 + | 96000 | | | |
| | 20% C11 | | | | |
| 63 | 20% H375 + | 45000 | | | |
| | 20% C12 | | | | |
| 64 | 20% H375 + | 73000 | | | |
| | 20% C13 | | | | |
| 65 | 20% H375 + | >100000 | | | |
| | 20% C14 | | | | |
| 66 | 20% H375 + | >100000 | | | |
| | 20% C15 | | | | |

### EXAMPLE 67 (ACCORDING TO THE INVENTION) AND 68 TO 71 (COMPARISON)

Table V shows an example for the use of random hydrophilic-hydrophobic copolymer as a component of the associative polymer thickener (example 67) in comparison with otherwise comparable thickeners which contain the hydrophilic homopolymer polyethylene glycol as usual as a water-soluble base chain (examples 68 to 71). In the case of an acceptable viscosity in water, the thickening effect in the test binder is approximately comparable with that of the corresponding comparative substances.

TABLE V
Polymerized copolymer PPG/PEG (1:4) polyglycol
similar polymers incorporated from units in the
thickener, without PPG moiety are too highly viscous
when 20% strength in water

| | | | Solution viscosity | Acronal viscosity (mPa · s) | | |
|---|---|---|---|---|---|---|
| | Mixture | | in water (mPa · s) | at a shear rate D of | | |
| | (% polymer | | (Brookfield, | | 100 | 10000 |
| Ex. | in water) | | 20 rpm) | 1 sec⁻¹ | sec⁻¹ | sec⁻¹ |
| 67 | 20% V3 | Inv. | 13500 | 41000 | 2600 | 54 |
| 68 | 20% V7 | Com. | >100000 | | | |
| 69 | 20% V7 + | Com. | 3000 | 60000 | 3600 | 62 |
| | 16% BDG | | | | | |
| 70 | 20% V2 | Com. | >100000 | | | |
| 71 | 20% V2 + | Com. | 2700 | 60000 | 3100 | 68 |
| | 16% BDG | | | | | |

### EXAMPLES 72 TO 75 (ACCORDING TO THE INVENTION)

Table VI shows examples in which the thinners (C) are also added to combinations of thickeners (A) having a structural viscosity and Newtonian thickness (B). As a result, the viscosity in water can be further reduced or the solids content of the thickener having a structural viscosity can be further increased.

TABLE VI
Trimeric mixtures of thickeners having a structural
viscosity, plus Newtonian thickeners, plus thinners

| | | Solution viscosity | Acronal viscosity (mPa · s) | | |
|---|---|---|---|---|---|
| | Mixture | in water (mPa · s) | at a shear rate D of | | |
| | (% polymer | (Brookfield, | | 100 | 10000 |
| Ex. | in water) | 20 rpm) | 1 sec⁻¹ | sec⁻¹ | sec⁻¹ |
| 72 | 5% H375 + | 3400 | | | |
| | 15% V4 + 20% C5 | | | | |
| 73 | 10% H375 + | 6200 | | | |
| | 10% V4 + 20% C5 | | | | |
| 74 | 10% H375 + | 24000 | | | |
| | 10% V4 | | | | |
| 75 | 15% H375 + | 13300 | 31000 | 5600 | 92 |
| | 5% V4 + 16% C5 | | | | |

The compositions of the individual model thickeners are shown in table VII.

TABLE VII
Composition of model thickeners

| Model | | | |
|---|---|---|---|
| thick- | | | |
| ener | Raw material in the molar ratio | | |
| V1 | 3 Polyethylene glycol | 6 Rhodasurf A60 | 4 Powderlink 1174 |
| | 8000 (Clariant) | (Rhodia) | (Cytec) |
| V2 | 1 Polyglycol 20000 | 3 Soprophor S40 | 2 Powderlink 1174 |
| | (Clariant) | (Rhodia) | (Cytec) |
| V3 | 1 Polyglycol | 4 Soprophor S40 | 4 Powderlink 1174 |
| | P41/12000 (Clariant) | (Rhodia) | (Cytec) |
| | | 2 Me-PEG 1100 | |
| | | (Clariant) | |
| V4 | 1 Polyethylene glycol | 2 Igepal CA 890 | 2 Powderlink 1174 |
| | 8000 (Clariant) | (Rhodia) | (Cytec) |
| V5 | 1 Polyethylene glycol | 2 Igepal CA 890 | 2 Powderlink 1174 |
| | 4000 (Clariant) | (Rhodia) | (Cytec) |
| V6 | 1 Polyethylene glycol | 2 Igepal CA 890 | 2 Powderlink 1174 |
| | 12000 (Clariant) | (Rhodia) | (Cytec) |
| V7 | 3 Polyethylene glycol | 4 Soprophor S40 | 4 Powderlink 1174 |
| | 8000 (Clariant) | (Rhodia) | (Cytec) |
| V8 | 1 Polyethylene glycol | 2 Igepal CA 890 | 2 Powderlink 1174 |
| | 2000 (Clariant) | (Rhodia) | (Cytec) |
| V9 | 1 Polyethylene glycol | 2 1-Nonanol | 2 Powderlink 1174 |
| | 8000 (Clariant) | (Merck) | (Cytec) |
| V10 | | 3 Igepal CA 890 | 1 Powderlink 1174 |
| | | (Rhodia) | (Cytec) |
| V11 | 1 Polyethylene glycol | 2 Igepal CA 890 | 2,2-hexamethylene |
| | 8000 (Clariant) | (Rhodia) | diisocyanate* |
| | | | (Merck) |
| V12 | 1 Polyethylene glycol | 2 Igepal CA 890 | 2,5-hexamethylene |
| | 8000 (Clariant) | (Rhodia) | diisocyanate* |
| | | | (Merck) |
| V13 | 1 Polyethylene glycol | 2 Neodol 91-8E | 2 Powderlink 1174 |
| | 8000 (Clariant) | (Shell) | (Cytec) |

*Reaction without catalyst, addition instead of Powderlink 1174
Polyglycol P41/12000 (random copolymer of propylene glycol and ethylene glycol 4:1, molecular weight 20000 (Clariant)
Igepal CA 890 (octylphenol ethoxylate, Rhodia)
Soprophor S40 (tristyryl ethoxylate, Rhodia)
Neodol 91-8E (C9 to C11 fatty alcohol ethoxylate, Shell)
Rhodasurf A60 (C18 fatty alcohol ethoxylate)
Powderlink 1174 (Glycoluril, Cytec)

The compositions of some model thinners are shown in table VIII.

TABLE VIII
Composition of the model thinners

| Model thinner | | | Boiling |
|---|---|---|---|
| (raw materials in molar ratio) | | | point |
| C1 | 1 Tetraethylene glycol | 1 Dimethyl adipate | >250° C. |
| C2 | 2 Tetraethylene glycol | 1 Dimethyl terephthalate | >250° C. |
| C3 | 1 Triethylene glycol | 1 Dimethyl adipate | >250° C. |
| C4 | 3 Triethylene glycol | 2 Dimethyl adipate | >250° C. |
| C5 | 4 Tetraethylene glycol | 3 Adipic acid | >250° C. |
| C6 | 4 Tetraethylene glycol | 3 Phthalic anhydride | >250° C. |
| C7 | 3 Tetraethylene glycol | 4 Adipic acid | >250° C. |
| C8 | 1 Polyethylene glycol | 1 Adipic acid | >250° C. |
| | 300 (Clariant) | | |
| C9 | 1 Polyethylene glycol | 1 Adipic acid | >250° C. |
| | 600 (Clariant) | | |

C10 Polyglycol B11/50 (monobutyl-terminated random copolymer of propylene glycol and ethylene glycol 1:1; Clariant)
C11 Polyglycol B01/50 (monobutyl-terminated polypropylene glycol; Clariant)
C12 Pluriol P900 (polypropylene glycol, BASF)
C13 Polyglycol M1100 (monomethyl-terminated polyethylene glycol, Clariant)
C14 Pluriol P6800 (polypropylene/ethylene glycol 3-block copolymer having 20% of PPG, BASF)
C15 Poly-THF 2900 (polybutylene glycol, BASF)
BDG (butyldiglycol)
PEG (polyethylene glycol)
PPG (polypropylene glycol)

Test Methods:

The viscosities of the aqueous solution which are stated in the tables were determined in a Brookfield RVT viscometer, at 20 rpm and 23° C., read after a measuring time of 2 minutes.

The Test System has the Following Design:

2.5 g of thickener solution are homogeneously stirred into a mixture of 100 g of Acronal 290D (styrene-acrylate dispersion, BASF), 30 g of demineralized water and 0.3 g of antifoam ADDID 800 (Wacker). After a ripening time of 4 hours the viscosity at 23° C. is determined in a Bohlin viscometer (measuring system PP 30, gap 150 μm) at the shear rates of 1 sec⁻¹, 100 sec⁻¹ and 10 000 sec⁻¹. For reasons of simplicity, the viscosity of the thickener is tested only in the binder alone since experience has shown that these values relate to those obtained on testing in a complete paint formulation.

1. An associative thickener preparation having a viscosity in aqueous solution of less than 25 000 mPa·s, comprising a combination of at least one associative thickener having a structural viscosity and at least one Newtonian associative thickener.

2. The associative thickener preparation as claimed in claim 1, comprising an associative thickener having a structural viscosity and a thinner, the thinner being a condensate of hydrophilic, water-soluble oligomeric and hydrophobic moieties.

3. The associative thickener preparation as claimed in claim 2, characterized in that the thinner is a copolymer or cooligomer of alternating hydrophilic and hydrophobic molecules or is a higher molecular weight ester, these substances having a boiling point of >250° C.

4. The associative thickener preparation as claimed in claim 2, characterized in that the hydrophobic component of the thinner is a bifunctional molecule X—R—X₂, where R is a saturated or unsaturated aliphatic or cycloaliphatic radical having 2 to 30 carbon atoms, preferably having 2 to 12 carbon atoms and particularly preferably having 3 to 6 carbon atoms, or an aromatic radical having 6 to 12 carbon atoms or a mixed aliphatic-aromatic radical and X and X₂, which may be identical or different and can react with the functional group Z or Z₂ (a group containing an active hydrogen, such as, for example, a hydroxyl group, or an amino or amido group) of the hydrophilic component, X and X₂ being selected from the radical of a carboxylic acid, of a carboxylic anhydride, of an acyl chloride, of an ester, of an isocyanate or of an epoxide or being a halogen ion.

5. The associative thickener preparation as claimed in claim 4, characterized in that the hydrophobic moiety is the radical of adipic acid, phthalic anhydride or dimethyl terephthalate.

6. The associative thickener preparation as claimed in claim 3, characterized in that the hydrophilic component of the thinner is an oligomer of the formula Z-[CH₂CH₂—O]ₘ—CH₂CH₂-Z₂, where m is 1 to 15, and Z and Z₂, which are identical to or different from one another, are a group containing an active hydrogen atom, for example an alcohol, an amino or a secondary amino group.

7. The associative thickener preparation as claimed in claim 6, characterized in that the hydrophilic component is selected from the group consisting of the short-chain polyethylene glycols.

8. The associative thickener preparation as claimed in claim 2, characterized in that the molar ratio of hydrophilic to hydrophobic moieties is about 6:5 to 5:6.

9. The associative thickener preparation as claimed in claim 2, characterized in that the thinner is selected from the group consisting of
(a) a copolymer of short-chain polyethylene glycol and adipic acid and/or phthalic anhydride;
(b) a copolymer of ethylene glycol and propylene glycol and/or butylene glycol;
(c) a random copolymer of ethylene glycol and propylene glycol and/or butylene glycol, the polyethylene fraction being from 40 to 90 mol %;
(d) oligomeric propylene glycol or oligomeric butylene glycol having, preferably, not more than 10 monomer units and mixtures thereof.

10. The associative thickener preparation as claimed in claim 2, characterized in that the proportion of the thinner is from about 5 to 50% by weight.

11. The associative thickener preparation as claimed in claim 2, characterized in that the thinner is obtainable by polycondensation and/or polyaddition from the hydrophilic components and the hydrophobic components.

12. The associative thickener preparation as claimed in claim 1, characterized in that either the associative thickener having a structural viscosity or the Newtonian associative thickener or both contain a copolymer or cooligomer of alternating hydrophilic and hydrophobic structural elements in the molecule.

13. The associative thickener preparation as claimed in claim 1, characterized in that a copolymer or cooligomer of alternating hydrophilic and hydrophobic components is incorporated as polymerized units in the thickener having a structural viscosity, the copolymer or cooligomer incorporated as polymerized units being a random copolymer.

14. The associative thickener preparation as claimed in claim 1, obtainable by polycondensation or polyaddition of PEG/PPG copolymers or cooligomers with diisocyanates, glycolurils, aminoplasts and/or hydrophobic groups.

15. The associative thickener preparation as claimed in claim 2, characterized in that the thinner is used either alone or in combination with an additional solvent and/or surfactant.

16. The associative thickener preparation as claimed in claim 15, characterized in that the solvent is butyldiglycol, butyltriglycol or hexanediol.

17. The associative thickener preparation as claimed in claim 15, characterized in that the surfactant is selected from the group consisting of wetting agents, antifoams, dispersants, leveling agents, coalescence agents and film-forming auxiliaries.

18. (canceled)

19. (canceled)

20. The associative thickener preparation as claimed in claim 3, characterized in that the hydrophobic component of the thinner is a bifunctional molecule X—R—X₂, where R is a saturated or unsaturated aliphatic or cycloaliphatic radical having 2 to 30 carbon atoms, preferably having 2 to 12 carbon atoms and particularly preferably having 3 to 6 carbon atoms, or an aromatic radical having 6 to 12 carbon atoms or a mixed aliphatic-aromatic radical and X and X₂, which may be identical or different and can react with the functional group Z or Z₂ (a group containing an active hydrogen, such as, for example, a hydroxyl group, or an amino or amido group) of the hydrophilic component, X and X₂ being selected from the radical of a carboxylic acid, of a carboxylic anhydride, of an acyl chloride, of an ester, of an isocyanate or of an epoxide or being a halogen ion.

21. The associative thickener preparation as claimed in claim 2, characterized in that either the associative thickener having a structural viscosity or the Newtonian associative thickener or both contain a copolymer or cooligomer of alternating hydrophilic and hydrophobic structural elements in the molecule.

22. The associative thickener preparation as claimed in claim 2, characterized in that a copolymer or cooligomer of alternating hydrophilic and hydrophobic components is incorporated as polymerized units in the thickener having a structural viscosity, the copolymer or cooligomer incorporated as polymerized units being a random copolymer.

23. The associative thickener preparation as claimed in claim 2, obtainable by polycondensation or polyaddition of PEG/PPG copolymers or cooligomers with diisocyanates, glycolurils, aminoplasts and/or hydrophobic groups.

24. The associative thickener preparation of claim 1 in combination with at least one thinner or solvent.

25. The associative thickener preparation of claim 1 in combination with at least one wetting agent.

26. The associative thickener preparation of claim 1 in combination with at least one solvent and at least one wetting agent.
